(19) United States
(12) Patent Application Publication
(10) Pub. No.: US 2005/0198007 A1
(43) Pub. Date: Sep. 8, 2005

(54) Method, system and algorithm for dynamically managing a connection context database

(75) Inventor: Valentin Ossman, Netanya (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: TEHUTI NETWORKS LTD.

(21) Appl. No.: 10/790,052

(22) Filed: Mar. 2, 2004

(51) Int. Cl. G06F 7/00

(52) U.S. Cl. 707/3

(57) ABSTRACT

A method for managing a connection context database comprises the steps of obtaining connection information, sensing the network load of each connection, and allocating system resources with high priority to active connections and low priority to inactive connections. This results in a dynamic context database which enables a limited number of resources to be best used by the most active connections. The method further comprises aggregating TCP/IP packets from the same connection based on information found in the dynamic context database. The processing time of TCP/IP packets received from a host is accelerated through the use of the dynamic context database for aggregation of two or more packets of the same connection.

### FIELD OF THE INVENTION

The present invention relates to communications networks, and particularly to methods and systems that reduce the time needed to process incoming Transmission Control Protocol (TCP)/Internet Protocol (IP) traffic at a receiving host CPU connected to a network.

### BACKGROUND OF THE INVENTION

The rapid growth of computer networks in the past decade has brought, in addition to well-known advantages, dislocations and bottlenecks in utilizing conventional network devices. For example, a CPU of a computer connected to a network may spend an increasing proportion of its time processing network communications, leaving less time available for other work. In particular, file data exchanges between the network and a storage unit of the computer, such as a disk drive, are performed by dividing the data into packets for transportation over the network. Each packet is encapsulated in layers of control information that are processed one layer at a time by the receiving CPU. Although the speed of CPUs has constantly increased, this type of protocol processing can consume most of the available processing power of even the fastest commercially available CPUs. A rough estimate indicates that in a TCP/IP network, one currently needs one hertz of CPU processing speed to process one bit per second of network data. Furthermore, evolving technologies such as IP storage, streaming video and audio, online content, virtual private networks (VPN) and e-commerce, require data security and privacy features such as IP Security (IPSec), Secure Sockets Layer (SSL) and Transport Layer Security (TLS) that increase even more the computing demands from the CPU. Thus, the network traffic bottleneck has shifted from the physical network to the host CPU.

The encapsulating IP protocol is described in RFC791 (http://www.faqs.org/rfcs/rfc791.html). TCP is a connection oriented communication protocol. TCP packets received by a computer from a network are classified by their connection. Each connection has its own database of parameters that are dynamically updated with any received packet. TCP and its connection establishment procedures are described in RFC793 (http://www.faqs.org/rfcs/rfc793.html).

In an IP network, the network packet size is labeled MTU (maximal transit unit). The maximal MTU allowed by the IP protocol is 64 K bytes. This is far bigger than the maximum 1500 bytes per packet allowed by an Ethernet network. This 1500 bytes limitation increases significantly the number of packets needed to transfer a given amount of data, adding a large per-packet processing overload to a receiving computer.

Existing solutions to this “bottleneck” problem include typically complete TCP offloading from software to hardware, requiring massive changes in the existing TCP/IP implementation on the host Operating System (OS). These solutions have two main disadvantages: higher cost and higher complexity.

Lindsay, in U.S. Pat. No. 6,564,267 B1, which is incorporated herein by reference, proposes another solution that requires complete synchronization between the TCP/IP stack implemented in the OS and a pre-processing method implemented in a Network Interface Card (NIC—also known as a network adapter). Lindsay's method has the NIC intercepting connection negotiation packets passing between the TCP layer and a remote endpoint in a synchronized way. These packets are both on the receive and the transmit paths, requiring the NIC to inspect both the received and the transmitted packets. Critical information extracted from and changed in those packets, together with additional information extracted from sequential packets is stored in a connection database and used by the NIC to aggregate small packets into larger packets. This process requires an entry in the connection database for every open connection, limiting the number of connections that may be served to the number of entries in the database. Lindsay's method is thus quite inefficient in terms of system resource use.

There is therefore a widely recognized need for, and it would be highly advantageous to have a low-cost, low-complexity and dynamically adaptable solution to the bottleneck problem created by the high packet rates on existing TCP/IP networks.

### SUMMARY OF THE INVENTION

The present invention discloses a method for managing a connection context database in a communications network. The present invention also discloses a method, system and algorithm for assisting and accelerating the processing of TCP packets received by a host CPU. More particularly, the invention discloses a method, system and algorithm for reducing the number of packets processed by the receiving TCP stack through pre-processing incoming packets in an aggregation unit using an inventive dynamic context database management. The resources needed by this pre-processing are allocated dynamically, allowing the algorithm to sense traffic inactivity from a connection and release resources to be used by other connections. In contrast with Lindsay's method, the method disclosed herein does not require synchronization with the connection negotiation process. The method substantially offloads the TCP reassembly effort (described in RFC793) from a receiving TCP implementation on a computer or system. The method reduces the packet-rate related tasks of the receiving computer or system, thereby reducing the processing time needed to process incoming TCP traffic. The main advantage of this method is that it does not require major modifications on a system implementing it, and that the result is fully compatible with the existing standards, RFC791 and RFC793.

According to the present invention, two or more TCP packets received at an aggregation unit can be aggregated into a larger TCP packet that is later processed by a TCP stack on the receiving computer or system. This aggregation reduces the number of packets received by the TCP stack, thus reducing the per-packet operations needed to reassembly the TCP stream as described by RFC973, and consequently reducing the processing time spent by the receiving computer or system on processing the received TCP packets. The aggregation of the received packets is done based on information found solely in those packets, without a need to intercept or change the connection negotiation packets as done in U.S. Pat. No. 6,564,267 B1 to Lindsay.

According to the present invention there is provided, in a communications network carrying data packet traffic, a method for managing a connection context database comprising the steps of: obtaining connection information defining a connection; responsive to a search in the context database for the connection, updating a network load sensing mechanism related to the connection; and using the network load sensing mechanism to manage the connection context database, whereby the method provides a dynamic database management that significantly accelerates the processing time of packets received by a host over a network.

According to the present invention, there is provided a method for dynamically managing a connection context database in a communications network comprising the steps of: receiving a packet in an aggregation unit; extracting connection information from the packet; searching the context database for the connection; if the connection is found, starting a timer for the connection, the timer dedicated to the connection and configured to stop after a determined time period, or, if the connection is not found, adding a new connection to the context database and starting a timer for the connection; and deleting the respective connection from the context database when its timer stops after the determined time period.

According to the present invention there is provided a method for accelerating the processing time of TCP/IP packets received by a host over a network, each packet carrying connection information, the method comprising the steps of: providing a dynamic context database that includes a plurality of connections; for each received packet, updating the corresponding connection in the dynamic context database and updating a network load sensing mechanism; aggregating at least two packets belonging to the updated connection in the context database to form an aggregated packet; and transmitting the aggregated packet to the host.

According to the present invention there is provided a system for accelerating the processing time of TCP/IP packets received by a host over a network, each packet carrying connection information, the system comprising: a dynamic context database used to store the context of a plurality of connections; a network load sensing mechanism operative to manage the dynamic database by updating and deleting connections; and an aggregation mechanism operative to aggregate at least two packets belonging to the same connection in the context database into an aggregated packet that can be further transmitted to the network.

### BRIEF DESCRIPTION OF THE DRAWINGS

Reference will be made in detail to preferred embodiments of the invention, examples of which may be illustrated in the accompanying figures. The figures are intended to be illustrative, not limiting. Although the invention is generally described in the context of these preferred embodiments, it should be understood that it is not intended to limit the spirit and scope of the invention to these particular embodiments. The structure, operation, and advantages of the present preferred embodiment of the invention will become further apparent upon consideration of the following description, taken in conjunction with the accompanying figures, wherein:

FIG. 1 (prior art) shows the IP header format of an IP packet, the TCP header format of a TCP packet and a complete TCP/IP packet;

FIG. 2 (prior art) shows the TCP reassembly process as described by RFC973;

FIG. 3 shows the formation of a TCP/IP aggregated packet including several TCP/IP packets;

FIG. 4 is a simplified flow chart that illustrates the main steps in a preferred embodiment of the method for dynamic context database management and packet aggregation of the present invention;

FIG. 5 shows an aggregation unit that includes a context database and a Large Receive (LR) algorithm, positioned in a network environment;

FIG. 6 shows details of the aggregation unit of FIG. 5 including details of the dynamic database;

FIG. 7 shows a flow chart of detailed steps in an exemplary use of the method of the present invention.

### DETAILED DESCRIPTION OF THE PREFERRED EMBODIMENTS

The present invention discloses a method for reducing the processing time spent by computer or system in processing received TCP packets. The processing time is reduced by means of reducing the number of packets received by the system or computer (i.e. by aggregating packets). The invention discloses a method for dynamic management of a connection context database used in the aggregation process. A “dynamic database” or “dynamically managed database” according to the present invention is a context database in which each entry (connection) is maintained for a given period of time, determined by a connection dedicated “delete” timer, after which time the connection is deleted. The aggregation method uses an algorithm referred to hereafter as the “Large Receive” or LR algorithm for aggregating two or more received packets into a larger packet. The present invention also discloses an aggregation unit for performing the reduction, the aggregation unit including a network load sensing mechanism (also called “delete timer” or “DelTimer”). The DelTimer keeps track of the network load for different connections in a context database. Accordingly, the present invention also discloses a method for managing a context database needed by the aggregation process.

Let “MAX_AGREG” be the maximal aggregated packet size obtainable with the method and algorithm of the present invention. The MAX_AGREG can have any value between the actual network MTU and 64K, the larger the better. However, MAX_AGREG may not necessarily always tend to have the largest possible value, e.g. in cases in which other system considerations may favor a smaller MAX_AGREG. Non-TCP/IP packets as well as irregular TCP packets bypass this algorithm and are directly transferred to the computer.

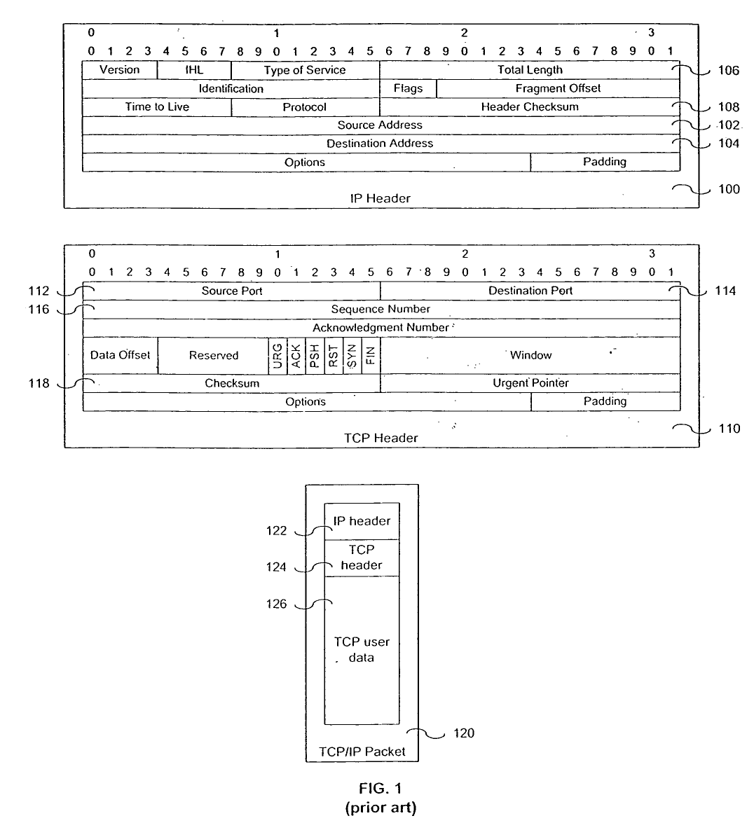

FIG. 1 shows the IP header format of an IP packet 100, the TCP header format of a TCP packet 110 and a full TCP/IP packet 120, with an IP header 122, a TCP header 124 and TCP user data 126, all known in prior art. Four parameters describing a connection can be extracted from the IP and TCP headers. These four parameters are:
a. an IP source address 102,
b. an IP destination address 104,
c. a TCP source port 112, and
d. a TCP destination port 114.
   Other parameters incorporated in the IP header include a Total Length 106 and a Header Checksum 108, while other parameters incorporated in the TCP header include a TCP Checksum 118.

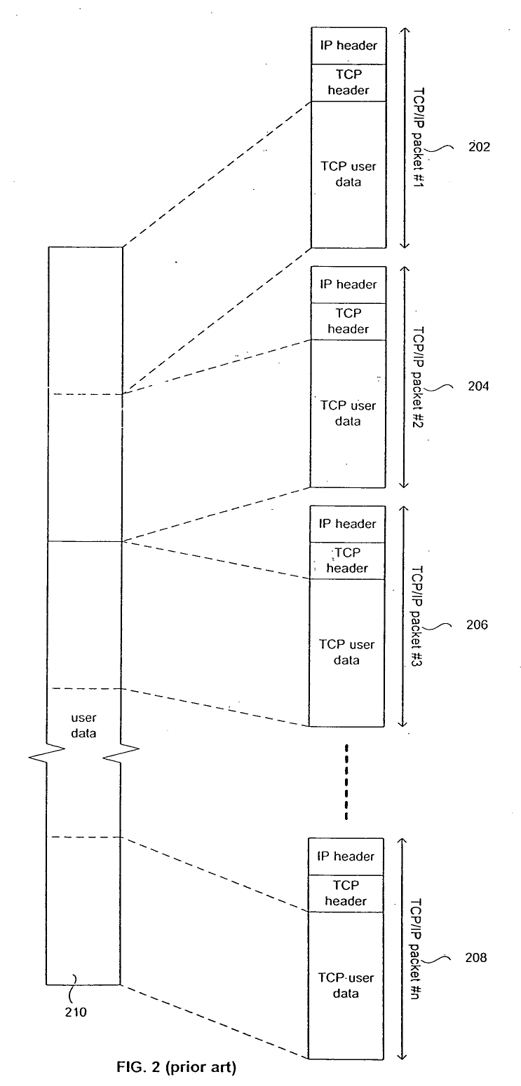

FIG. 2 shows a prior art reassembly process performed by the TCP on incoming packets 202, 204, 206 and 208. Here, four packets are shown as an example, with the understanding that in general, packet 208 is a n^{th} packet. Each received packet is classified by its connection. The packet is further positioned in an incoming (received) data stream 210, based on its unique TCP sequence number 116.

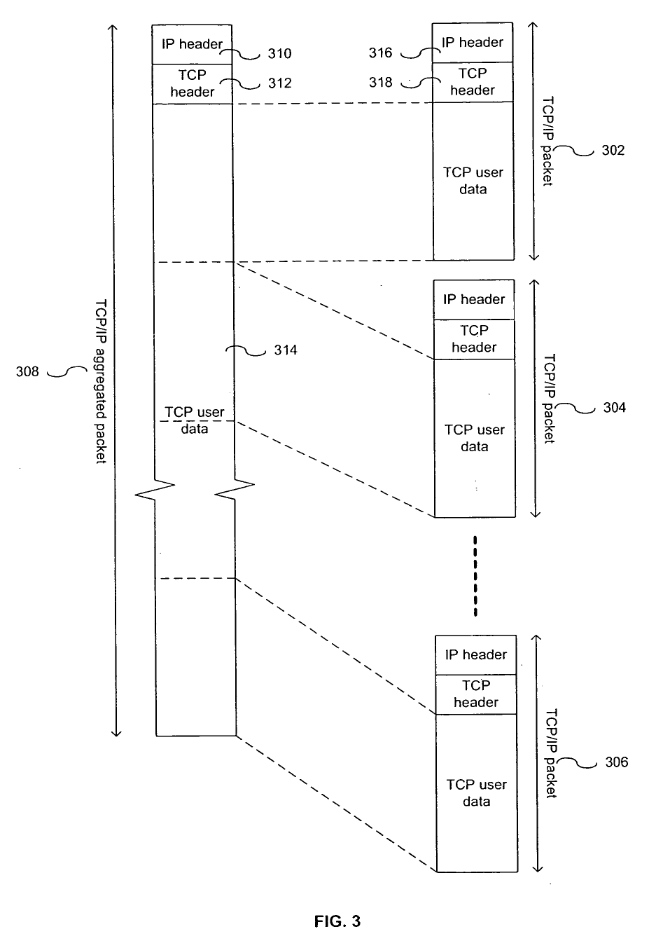

FIG. 3 describes an aggregated packet according to the present invention. The aggregated packet is preferably obtained using the method and the LR algorithm of the present invention, described in more detail below. In the figure, exemplary packets 302, 304 . . . 306 are input to the LR algorithm, with the result being an aggregated output packet 308. In the example, packets 302, 304 . . . 306 are “aggregable” packets, each smaller than 64 Kbytes. They may be aggregated into a larger aggregated packet 308 if the size of the aggregated packet is not greater then 64K bytes, and if their TCP Sequence Number 116 had instructed the TCP reassembly algorithm to place them sequentially in a received data stream. The user data in aggregated packet 308 is the aggregated data of packets 302, 304 . . . 306 as ordered by the TCP Sequence Number 116 in their respective original packets. The TCP/IP header of the aggregated packet includes an aggregated IP header 310 and an aggregated TCP header 312. This aggregated TCP/IP header is similar to the header of the first packet 302, which includes an IP header 316 and a TCP header 318, but incorporates the following changes:
a. Total Length 106 in the IP header is changed to show the size of the aggregated packet.
b. Header Checksum 108 in the IP header is changed to reflect the changes in the IP header.
c. TCP Checksum 118 in the TCP header is changed to reflect the changes in the TCP user data that now include data aggregated from several packets. The checksum calculation and replacement steps (marked b and c above) may be skipped in systems that entrust this operation to an NIC.

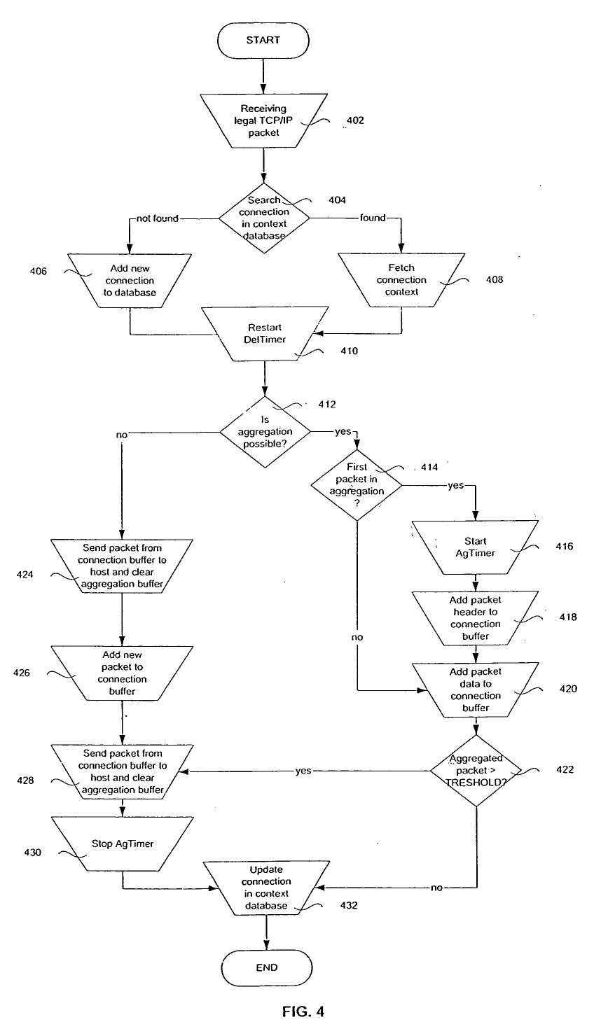

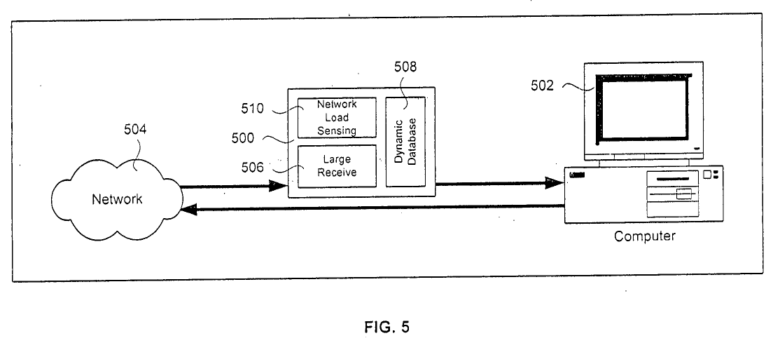

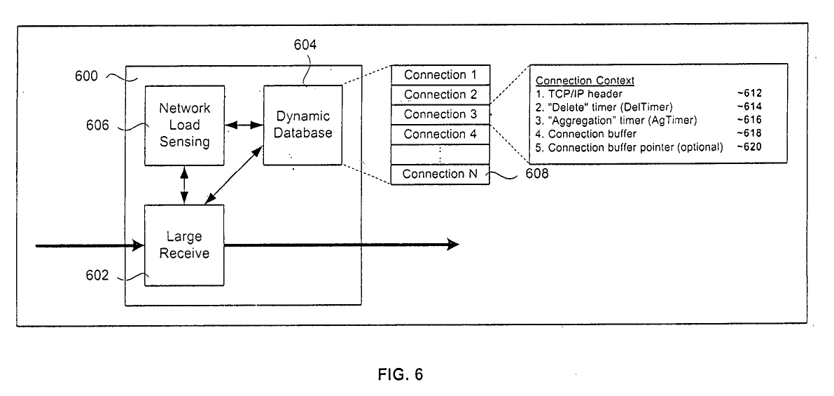

FIG. 4 is a simplified flow chart that illustrates main steps in a preferred embodiment of the method for dynamic database and packet aggregation of the present invention. Elements of a system implementing the method and algorithm are described in more detail in FIGS. 5 and 6. An aggregation unit (see description of FIGS. 5 and 6) receives legal TCP/IP packets in step 402. Legal TCP/IP packets are those packets that do not have IP or TCP checksum errors, and in which the TCP and IP headers are correct. Based on the connection information of each received packet (source and destination addresses and ports), a search for that connection's context is performed in a context database (see FIG. 5) in step 404. If the connection is found in the context database, the corresponding context is fetched in step 408. Else (connection not found in the context database), a new entry is added to the database to reflect the newly arrived packet in step 406. Each entry in the context database includes the following fields, shown in more detail in FIG. 6:
(i) a TCP/IP header 612 of the aggregation packet: this is the header of the first packet in the aggregation, with its total length changed every time new data is added to the aggregation.

(ii) a delete timer (DelTimer) 614: this timer is restarted every time a packet from this connection is detected and is used for deleting connections that are inactive for a certain period of time. If the timer was not restarted for a period of time (set when restarted) then the timer pops and triggers an expiration event that deletes the connection. Therefore, DelTimer is an “inactivity” timer, dedicated per connection.

(iii) an aggregation timer (AgTimer) 616: this timer is started every time a new aggregation is started and is used to prevent a situation in which an aggregated packet is delayed for too long before it is sent to the host.
(iv) a Connection buffer 618: this buffer holds the aggregated packet.
(v) an optional Connection buffer pointer 620: this pointer points to the end of the aggregated packet. This element is optional since it can be calculated from the TCP packet header but its presence adds simplicity to the implementation.

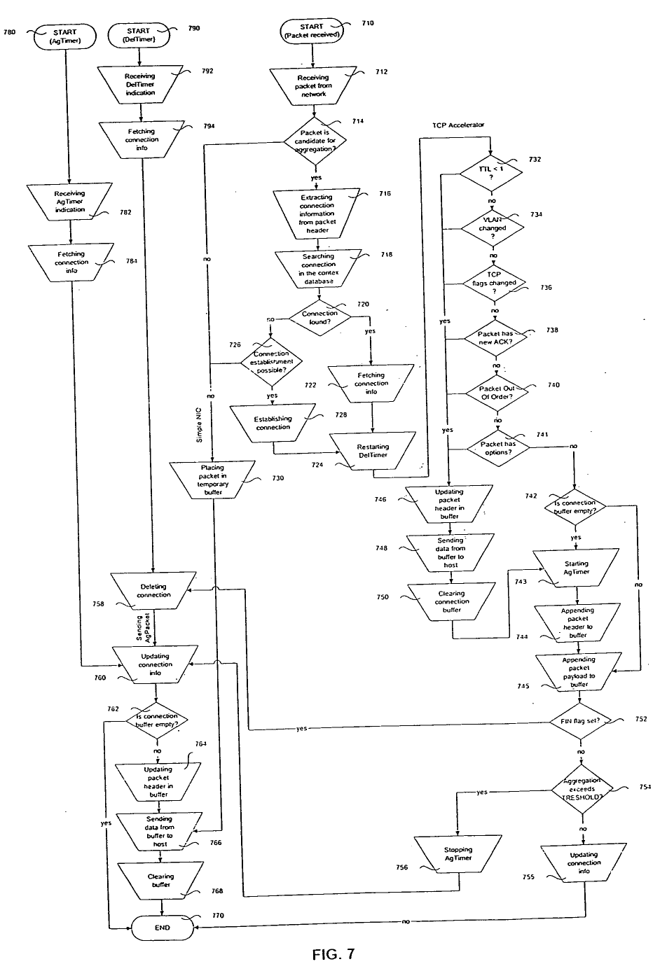

The DelTimer of the connection is now restarted in step 410 to indicate that the connection is still active. A check 412 is performed to see if a new packet can be added (i.e. is an “aggregable” packet) to an aggregated packet of this connection. This check is equivalent to checks 732-741 of FIG. 7, resulting in “yes” if all checks 732-741 result in a path to step 742 (FIG. 7) or resulting in “no” if all checks 732-741 result in a path to step 746 (FIG. 7). If aggregation is possible (“yes”), then a second check 414 is run to see if this new packet is the first packet in the aggregation. If yes, the AgTimer is started in step 416, the packet header is added to the connection buffer in step 418 and the packet data is added to the connection buffer in step 420. Else (“no” in second check 414) only the data of this new packet is added to the connection buffer in step 420.

A third check is performed in step 422 to see if the aggregated packet size exceeds a certain threshold. If the aggregated packet is smaller than the threshold (“no”) the connection context is updated in the context database in step 432. If the aggregated packet is larger than the threshold, the aggregated packet is sent from the connection buffer to the host in step 428, the AgTimer is stopped in step 430 and the context is updated in the context database in step 432.

In case the check in step 412 found that the aggregation was not possible, the aggregated packet corresponding to the connection of the new packet is sent to the host in step 424. The new packet is added to the connection buffer in step 426 and the new packet is also sent to the host in step 428. The AgTimer of the connection is stopped in step 430, and the context database is updated in step 432.

FIG. 5 and FIG. 6 show a system implementing the LR algorithm. The system comprises an aggregation unit 500 interposed on the receive path between a host computer 502 and a network 504. Packets arriving from network 504 are processed by unit 500 and then sent to the host. Unit 500 is described in detail in FIG. 6 (where it is numbered 600). Unit 500 runs an LR algorithm 506 (602 in FIG. 6), maintains a dynamic database 508 (604 in FIG. 6) and includes a network load sensing mechanism 510 (606 in FIG. 6) that works in conjunction with (or is implemented as) “DelTimer” 614 in order to keep track of inactive connections left in the dynamic database. Database 604 is composed of multiple entries (“connections 1 . . . N”) 608. Each connection contains a context formed from elements 612, 614 . . . 620. An inactive connection is considered to be a connection whose DelTimer expired (or “popped”), meaning that no packets were received by that connection for a predefined period of time. This implementation of the network sensing mechanism is given herein as an example only, with the understanding that there are other ways to implement it. Dynamic database 604 is updated with each packet received from the network, as well as by the expiration of either of the wo timers (AgTimer or DelTimer, see FIG. 6) of a connection present in the context database. The aggregation unit can be implemented outside the host (as in FIG. 5), but may also be implemented in the host on its NIC. Alternatively, a software implementation of the LR algorithm may be run on a processor assisting the main system CPU.

In summary, unit 500 receives small packets 302, 304 . . . 306 from the network, aggregates them into larger aggregated packet 308, and sends only aggregated packet 308 to the host.

### EXAMPLE

FIG. 7 shows a flow chart of detailed steps in an exemplary use of the method of the present invention. As in FIG. 4, this example covers both the innovative dynamic context database management and the packet aggregation using this dynamic database. This is an exemplary, detailed implementation of the packet aggregation method and the LR algorithm on a network interface card (NIC). It will be apparent to one skilled in the art that some of the steps indicated have equivalents, or may be missing altogether in some implementations. In this particular example there are 3 events (entry points) that can activate the algorithm, each having a different starting point. These events are listed below:
(i) the reception of a packet from the network (step 710).
(ii) the reception of an AgTimer indication (step 780).
(iii) the reception of a DelConnection indication (step 790).
   Each entry point and the subsequent steps in the algorithm are now described in more detail.

(i) Packet is Received from the Network

Upon reception of an indication that a new packet arrived from the network (step 710), the packet is received in step 712 and a first check is run in step 714 to determine if the packet is a candidate for aggregation. This includes checking if the packet type is a legal TCP/IP packet, if the IP and TCP checksums are correct, if the packet does not contain any errors and if the packet is not an IP fragment. In general, there may be more checks, depending on the implementation. The packet is now processed via one of two paths: a “Simple NIC” path or a “TCP Accelerator” path.

Simple NIC path: if one or more checks fail (i.e. the new packet is not a candidate for aggregation), the new packet is placed in a temporary buffer in step 730, then sent to the host in step 766, while the buffer is cleared in step 768, ending the algorithm in step 770. Else (the new packet is a candidate for aggregation), the information needed to identify its connection is extracted from the packet header in step 716. This information includes the IP source and destination addresses and the TCP source and destination ports. A lookup is then performed in the connection context database in step 718, and a check to see if the connection is found is run in step 720. If the connection is found, the connection information is fetched in step 722. Else (connection not found) another check is run in step 726 to check if it is possible to establish a new connection in the context database. If yes, a new connection is established in step 728, the connection delete timer (DelTimer) is started in step 724 and the flow continues through the “TCP Accelerator” path, as described below. If it is not possible to establish a new connection (“no” in 726), the new packet is sent to the host through the 730, 766 and 768 path above.

TCP Accelerator path: the various TCP/IP header parameters are checked in a series of six secondary (sub-) checks 732-741. These checks include: is the time to live (TTL) less than 1 (732)? or, is the virtual LAN (VLAN) in the header different from the one in the connection information (734)? or, are the TCP flags in the header different than those stored in the connection information (736)? or, is the ACK value in the header different from the value in the connection information (738)? or, is the packet out of order relatively to previously received packets, i.e. is the expected sequence number (SSN) different from the last packet SSN+ data length (740)? or, does the packet have IP or TCP options (741)?

If the answer to any of these six sub-checks is “yes”, then the packet is not suitable for aggregation with previously received packets. Therefore, previously aggregated data in the connection buffer are prepared to be sent to the host by updating the packet header in the buffer in step 746 to reflect the new packet length and new TCP and IP checksums (see FIG. 1 for Total Length and TCP and IP checksums position in header). The checksums are not a must if the host OS supports the features of IP and TCP checksum “offload”, as specified for example in “Offloading TCP/IP Checksum Tasks” in Microsoft MSDN (http://msdn.microsoft.com/library/enus/network/hh/network/209off1_{—}3×47.asp). The packet from the connection buffer is then sent to the host in step 748, and the buffer is cleared in step 750. The path then continues by adding the new packet to the connection buffer through steps starting at 743 as described below.

If the answer to all of the six sub-checks (732, 734, 736, 738, 740 and 741) is “no”, then the packet data can be added to (aggregated with) the previously received packets of the same connection (if there are such packets), to form an aggregated packet as shown in FIG. 3. If there are no previously received packets, a new aggregated packet starts with the packet itself. A check is done in step 742 to see if connection buffer is empty. A positive answer (“yes”) to this check means that a new aggregated packet is to be built in the connection buffer by starting the AgTimer (step 743) and by adding the packet header (step 744) and the packet data (payload) (step 745). Else, if the connection buffer is not empty (“no” in 742), then an aggregated packet has already been started in the connection buffer, and therefore only the packet data is added to the connection buffer (step 745).

A check is then run in step 752 to see if a TCP finish (FIN) flag is set on the newly received packet. If the FIN flag is set (“yes”) then the aggregated data must be sent to the host through a path that includes deleting the connection from the context database (step 758) and sending the aggregated packet through a series of additional steps starting at step 760, and described below. The deletion of the connection from the context database in step 758 stops all the connection timers. Else (if the FIN flag is not set i.e. “no” in step 752), the aggregated data size is checked to see if it exceeds a certain threshold “THRESHOLD” in step 754. If it does not (“no” in 754) the connection information is updated in step 755, and the algorithm comes to an end in step 770. Else, (“yes” in 754), the AgTimer is stopped (step 756) and the aggregated data in the connection buffer is sent to the host through the “Sending AgPacket” sequence starting at step 760. The threshold value limits the size of the largest aggregated packet in the connection buffer. The performance improvement of the LR algorithm is proportional to the size of this threshold. The maximal size of the threshold is given below:
THRESHOLDₘₐₓ=MAX_{—}AGREG−MTU

“Sending AgPacket” sequence: First, the connection information is updated in step 760. A check is run in step 762 to see if the connection buffer is empty. If “yes”, the algorithm ends in step 770. Else (“no” in 762), the packet header is updated in the buffer in step 764, the packet is sent through steps 766 and 768 described above, and the algorithm ends in step 770.

(ii) Reception of an AgTimer Indication

The AgTimer guaranties a known maximal delay from the moment of arrival of the first packet in the aggregation to the time it is sent to the host. Each connection has its individual AgTimer, started when data is added to an empty connection buffer (step 743) and stopped when the connection buffer is cleared (step 760). The AgTimer is active only while there is data in the connection buffer. The AgTimer “pops”, i.e. gives an indication that a period of time has elapsed after it finishes waiting for the time period set when the timer is started. The algorithm starts (point 780) when a connection AgTimer pops in step 782. The connection information is fetched from the context database in step 784 in the same way as in step 722. The flow then continues to the “Sending AgPacket” sequence, steps 760-770.

(iii) Reception of a DelTimer Indication

The DelTimer triggers a delete operation of a connection from the context database after a given (e.g. predetermined) period of inactivity of that connection. Each connection has its own DelTimer. This mechanism permits to clean the context database of inactive connections and to make room instead for active connections, enabling a robust solution that can handle many connections by adapting itself to best serve active connections. A connection that does not fit in the context database will be served through the “Simple NIC” path, without performance improvement on the host. An entry in the context database is built in step 728 when a “candidate for aggregation” packet from an unknown connection is detected. The connection information in the context database is deleted by receiving a packet with the FIN flag as previously described from step 752 or, by the pop of the DelTimer (step 790) which is restarted every time a packet arrives to a connection in step 724, and stopped only when the connection is deleted. The DelTimer pops after it finishes waiting for the time period set when the timer is started. If the DelTimer pops, a DelTimer indication triggers the LR algorithm. An indication received in step 792 shows which connection DelTimer has popped. Then, the relevant connection information is fetched from the context database in step 794, in the same way as in step 722. The connection is deleted through the same steps as in the case of arrival of a packet with a FIN flag, through steps 758, 760, 762, 764, 766, 768. The algorithm then ends in step 770.

The method, system and algorithm disclosed herein use (or in the case of the system include) and handle a connection context database, which is updated dynamically based on the received traffic shape, and which does not need to be synchronized to the database held by the receiving host TCP implementation. The aggregation process makes use of this context database to aggregate received packets. Packets are aggregated based on attribution to the same connection and their sequence number. The order (sequence) of arrival of packets to be aggregated is not important. The algorithm determines if a packet can be aggregated with at least one other packet, performs the aggregation, and sends the aggregated packet to the host when the aggregated packet reaches an optimal size, which cannot exceed the MTU. This algorithm has the advantage of not needing to make any changes in the OS running on the host computer since the aggregated packet is a legal TCP/IP packet that can be accepted by the computer. Moreover, synchronization is not needed at any time for any procedure, in contrast with Lindsay's method. The present method is “dynamic” in the sense that it constantly updates connections information in a context database and is able to utilize the database (and system) resources to fit best the traffic demands. In contrast with known aggregation techniques, the present method uses a timer to delete a connection from the context database after a given inactivity period, thereby freeing space in the database for new connection contexts.

In summary, a host computer or system that receives packets processed through the aggregation unit/LR algorithm of the present invention, receives fewer packets of larger size, thereby reducing the processing time needed for all the small packets. It is estimated that this algorithm can improve the TCP processing time on the computer by a factor of 43, calculated by the maximum number of 1500 bytes packets that can be aggregated into a 64K bytes (65536 bytes) aggregated packet.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. In a communications network carrying data packet traffic, a method for managing a connection context database comprising the steps of:
a. obtaining connection information defining a connection;
b. responsive to a search in the context database for said connection, updating a network load sensing mechanism related to said connection; and
c. using said network load sensing mechanism to manage the connection context database;
whereby the method provides a dynamic database management that significantly accelerates the processing time of packets received by a host over a network.

2. The method of claim 1, wherein said step of obtaining connection information includes receiving a packet associated with said connection and extracting said connection information from said packet.

3. The method of claim 2, wherein said receiving a packet includes receiving a TCP/IP packet.

4. The method of claim 3, wherein said connection information includes a source IP address, a destination IP address, a source TCP port and a destination TCP port.

5. The method of claim 2, wherein said step of updating a network load sensing mechanism related to said connection includes starting a connection dedicated delete timer for each said associated packet of said connection, and wherein said step of using said network load sensing mechanism to manage the connection context database includes deleting said connection from the context database after an expiration event using said dedicated connection timer.

6. The method of claim 5, wherein said starting said connection delete timer includes starting said delete timer for a predefined time period for each said associated packet belonging to said connection, and wherein said deleting said connection after an expiration event includes deleting said connection from the database when said delete timer stops.

7. The method of claim 5, wherein said starting said connection delete timer for each said associated packet belonging to said connection includes adding a new entry for said connection to the context database if said connection is not found in the context database.

8. The method of claim 5, wherein said starting said connection delete timer for each said associated packet belonging to said connection includes starting said delete timer if said connection is found in the context database.

9. A method for dynamically managing a connection context database in a communications network comprising the steps of:
a. receiving a packet in an aggregation unit;
b. extracting connection information from said packet;
c. searching the context database for said connection, and if said connection is not found;
d. adding a new connection to the context database;
e. starting a timer for said new connection, said timer dedicated to said new connection and configured to stop after a determined time period; and
f. deleting said new connection from the context database when said timer stops after said determined time period.

10. The method of claim 9, wherein said step of receiving a packet includes receiving a TCP/IP packet;

11. The method of claim 10, wherein said connection information includes a source IP address, a destination IP address, a source TCP port and a destination TCP port.

12. A method for managing a connection context database in a communications network comprising the steps of:
a. receiving a packet in an aggregation unit;
b. extracting connection information from said packet;
c. searching the context database for said connection, and, if said connection is found;
d. starting a timer for said connection, said timer dedicated to said connection and configured to stop after a determined time period; and
e. deleting said connection from the context database when said timer stops after said determined time period.

13. The method of claim 12, wherein said step of receiving a packet includes receiving a TCP/IP packet;

14. The method of claim 13, wherein said connection information includes a source IP address, a destination IP address, a source TCP port and a destination TCP port.

15. A method for accelerating the processing time of TCP/IP packets received by a host over a network, each packet carrying connection information, the method comprising the steps of:
a. providing a dynamic context database that includes a plurality of connections;
b. for each received packet, updating a corresponding connection of said packet in said dynamic context database and updating a network load sensing mechanism;
c. aggregating at least two packets belonging to a said updated connection in said context database to form an aggregated packet; and
d. transmitting said aggregated packet to the host.

16. The method of claim 15, further comprising using said network load sensing mechanism to allocate dynamically priorities to said connections, from a highest priority to a most active connection to a lowest priority to an inactive connection.

17. The method of claim 15, wherein the load sensing mechanism is implemented as a connection delete timer dedicated to each said connection, wherein said step of updating a load sensing mechanism includes starting said connection delete timer for a predefined time period for each packet belonging to said corresponding connection, and wherein said step of deleting a connection from said database upon a command of said load sensing mechanism includes deleting said corresponding connection from said context database when said delete timer stops.

18. The method of claim 17, wherein said step of updating further includes searching said context database for said corresponding connection and, if said corresponding connection is not found, adding a new connection and starting said connection delete timer.

19. The method of claim 17, wherein said step of updating further includes searching context database for said corresponding connection and, if said corresponding connection is found, starting said connection delete timer.

20. The method of claim 16, wherein said step of deleting said connection from said database upon a command of said load sensing mechanism includes deleting said inactive connection.

21. A system for accelerating the processing time of TCP/IP packets received by a host over a network, each packet carrying connection information, the system comprising
a. a dynamic context database used to store the context of a plurality of connections;
b. a network load sensing mechanism operative to manage said dynamic database by updating and deleting said connections; and
c. an aggregation mechanism operative to aggregate at least two packets belonging to a same said connection in said context database into an aggregated packet that can be further transmitted to the network.

22. The system of claim 21, wherein said dynamic database includes, for each said connection, a timer that operates in coordination with said network sensing mechanism to perform said deleting.

23. The system of claim 21, wherein said network load sensing mechanism operativeness to manage said dynamic database by updating and deleting said connections is provided by a delete timer dedicated per connection that deletes a connection from the database after a predefined connection inactivity time.
